(19) United States
(12) Patent Application Publication
(10) Pub. No.: US 2011/0109188 A1
(43) Pub. Date: May 12, 2011

(54) Partial Discharge Resistant Motor Slot Insulation

(76) Inventors: Clark D. Shaver, Inola, OK (US); Sean A. Cain, Owasso, OK (US)

(21) Appl. No.: 12/616,032

(22) Filed: Nov. 10, 2009

(51) Int. Cl. H02K 3/34

(52) U.S. Cl. 310/215

(57) ABSTRACT

Systems and methods for reducing or preventing partial discharge between turns of a single coil within an electric motor by placing insulating barriers between different pluralities of wire turns in a single coil. One embodiment comprises an electric motor. The motor includes a rotor and a stator, where the stator has multiple coils of wire that are positioned in passageways in the stator to form electromagnets. Each wire coil has multiple wire turns, and insulating barriers are positioned between different sets of wire turns within the coil. In one embodiment, the stator includes a slot liner in each passageway to electrically isolate all of the wire turns in each coil from the walls of the passageway. The wire coils may be formed with wire that has an insulating coating which is separate from the insulating barriers.

### BACKGROUND

1. Field of the Invention

The invention relates generally to random wound electric motors, and more particularly to systems and methods for preventing partial discharge between turns of wire within a coil in an electric motor. Additionally, the invention provides increased insulation strength between the highest potential turns and the ground wall.

2. Related Art

A typical electric motor has two primary components: a rotor; and a stator. The stator is a stationary component, while the rotor is a movable component which rotates within the stator. Typically, in a DC motor, or in a permanent magnet motor, one or the other of these components has a permanent magnet, while the other uses coils of electrical wire to generate changing magnetic fields. In an AC induction motor or synchronous motor, a magnetic field is induced into the rotor. The interaction of the magnetic fields created by the stator and the rotor cause the rotor to rotate within the stator.

The motor incorporates electromagnets that generate changing magnetic fields when current supplied to the electromagnets is varied. These electromagnets are normally formed by wrapping insulated wire around a ferromagnetic core. When electric current is passed through the wire, magnetic fields are generated around the wire and consequently in the ferromagnetic core. Changing the magnitude and direction of the current changes the magnitude and polarity of the magnetic fields generated by the electromagnet.

As noted above, the wire that is used to form the electromagnets is insulated. As the wire is wrapped around the core, each turn of the wire typically overlaps one or more other turns of wire. If the wire were not insulated, the different turns of wire would be electrically coupled and would cause a short-circuit. Even if the turns of wire were not physically touching, there could be an electrical discharge between them because of their close proximity. In addition to the insulation around the wire, electric motors often require ground wall insulation. Ground wall insulation is insulation that is positioned between the turns of wire and a grounded wall or other structure in which (or near which) the coil is located. Ground wall insulation is used to prevent electrical discharge between wires that have very high potentials and the ground wall.

It should be noted that, as used herein, a “turn” of wire is a loop or segment of wire that wraps one time around the core. A “coil” is used herein to refer to a set of one or more turns of wire that are wrapped around a core to create an electromagnet.

Some electric motors are designed so that the potential difference between turns of wire in a coil is very large. The potential difference between turns of wire may be sufficiently high that the voltage stress between the wire turns may allow an electrical discharge to occur. “Partial discharge” is a partial dielectric breakdown of an insulator. This breakdown occurs in small isolated areas in the insulator, often at weak points such as small gas bubbles, voids or inclusions in the insulator. Partial discharge is seen most often in high voltage applications where potential levels are high and non-uniform electric fields generate accentuated electrical stresses. Any small inclusion or void in the high potential area of the insulation system is more likely to breakdown, creating a discharge in the void. These small discharges span across the void, and do not discharge across the entire insulating material. Consequently, it is only a partial discharge. Partial discharges cause insulation to deteriorate, making further partial discharges more likely.

Prior art systems have attempted to reduce voltage stress in various ways. For example, coils may be form-wound. In a form-wound coil, the wire of each turn is positioned in a known location with respect to the other turns. Thus, a turn of wire that will have a particular potential is positioned next to turns of wire that have relatively small potential differences from the first turn and therefore have low voltage stress with respect to that turn. In random wound machines, it is not possible to ensure that wire turns are positioned to minimize voltage stress. Eventually, partial discharges may cause enough insulation to deteriorate resulting in a complete insulation failure causing the motor to become non-functional and requiring the motor to be repaired or replaced.

Other systems have used additional wire insulation, insulation between wire coils, and insulation that includes a conducting or semi-conducting layer to limit discharges between wires. It would, however, be desirable to provide means to reduce electrical stresses between turns of a single coil and thereby reduce or prevent partial discharges within the coil.

### SUMMARY OF THE INVENTION

The present invention includes systems and methods for reducing or preventing partial discharge between turns of a single coil within an electric motor. One embodiment comprises an electric motor, such as may be used to drive an electric submersible pump. The motor includes a rotor and a stator, where the stator has multiple coils of wire that are positioned in passageways in the stator to form electromagnets. Each wire coil has multiple wire turns, and insulating barriers are positioned between different sets of wire turns within the coil. In one embodiment, the stator includes ground wall insulation (a slot liner) in each passageway to electrically insulate all of the wire turns in each coil from the walls of the passageway. The wire coils may be formed with wire that has an insulating coating which is separate from the insulating barriers.

The insulating barriers within each passageway may be separate from or integral to the slot liner. If the insulating barriers are separate from the slot liner, they may, for example, comprise individual tubular insulators that are positioned within the slot liner. The slot liner and/or insulating barriers may be formed by extrusion, spiral-winding, or other means. If the insulating barriers are integral to the slot liner, they may, for instance, be extruded. The insulating barriers may be located within the slot liner to position a first set of wire turns (e.g., including a first wire turn having a maximum electrical potential) apart from a second set of wire turns (e.g., including a last wire turn having a minimum electrical potential) in order to provide further isolation of these sets of wire turns.

Another embodiment comprises a method for manufacturing a stator for an electric motor. The method includes providing a stator body having a plurality of passageways therethrough and installing insulating barriers within each passageway. Within each passageway, multiple wire turns of a single wire coil are installed so that the insulating barriers within the passageway isolate and potentially physically separate a first set of the wire turns from a second set of the wire turns within the same wire coil. The method may also include installing a slot liner within each of the passageways to isolate all of the wire turns within the passageway from the walls of the passageway

Still another embodiment of the invention comprises an electromagnet in an electric motor. The electromagnet includes a ferromagnetic core and a wire coil positioned around the ferromagnetic core. The wire coil is a single wire that forms multiple loops or turns of wire. The electromagnet also includes insulating barriers that isolate and potentially physically separate a first set of the wire turns from a second set of the wire turns. The electromagnet may be used in either a stator or a rotor of an electric motor.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the general structure of an electric motor.

FIG. 2 is a diagram illustrating the end of a stator body in accordance with one embodiment.

FIG. 3 is a perspective view of wire turns within a single slot of a stator body in accordance with one embodiment.

FIG. 4 is a cutaway view of the wire turns in a slot of a stator body in accordance with one embodiment.

FIG. 5 is a cutaway view of the wire turns in a slot of a stator body in accordance with an alternative embodiment.

FIG. 6 is a cutaway view of the wire turns in a slot of a stator body in accordance with another alternative embodiment.

FIG. 7 is a cutaway view of the wire turns in a slot of a stator body in accordance with another alternative embodiment.

FIG. 8 is a cutaway view of the wire turns in a slot of a stator body in accordance with another alternative embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for preventing partial discharge between turns of wire within a coil in an electric motor.

In one embodiment, a coil is constructed by threading wire through slots in a stator. Before the wire is threaded through the slots, an insulating slot liner is inserted into each slot. The slot liner will insulate all of the wires in the coil from the walls of the slot. Further, one or more tubular insulators are provided within the slot liner. Each of these additional tubular insulators will contain a different subset of the turns of wire that comprise the coil, and will insulate that subset of turns from other turns in the slot.

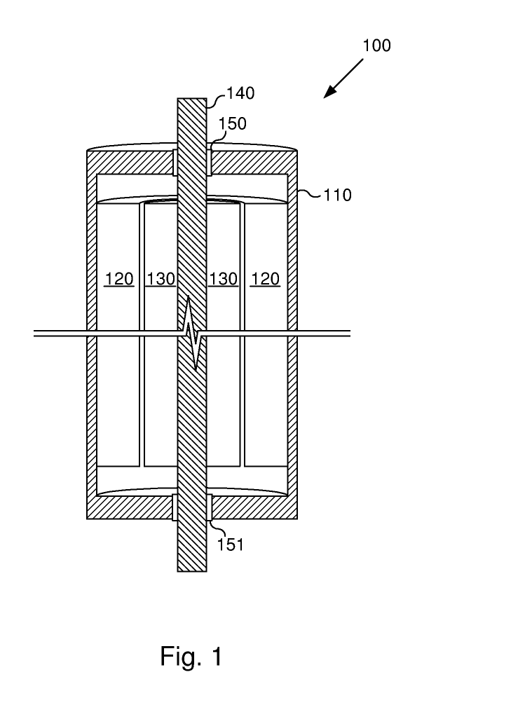

Referring to FIG. 1, a diagram illustrating the general structure of an electric motor is shown. As depicted in the figure, motor 100 has a housing 110 that contains a stator 120 and a rotor 130. Stator 120 remains stationary within housing 110. Stator 120 has a generally annular shape (cylindrical with a coaxial cylindrical space in the middle). Rotor 130 is generally cylindrical in shape and is coaxially positioned within the cylindrical space in the center of stator 120. Rotor 130 has a shaft 140 that runs through the center of it. Shaft 140 is held in position within housing 110 by bearings 150 and 151. Shaft 140 can rotate within bearings 150, 151, thereby allowing rotor 130 to rotate within stator 120.

Rotor 130 is caused to move within stator 120 by changing magnetic fields. Each of these components (stator 120 and rotor 130) creates a magnetic field. The interaction of these magnetic fields causes rotor 130 to move within stator 120. It should be noted that the invention relates to the coils that are used to generate the magnetic fields, and can be implemented in either the stator or the rotor of various types of motors, including AC induction motors, DC motors, and the like.

In one embodiment, an electric AC induction motor incorporates one or more electromagnets into the stator to create changing magnetic fields. The magnetic fields generated by the stator induce an electromotive force in the rotor, effectively creating another set of electromagnets that generate corresponding magnetic fields and cause the rotor to turn within the stator. Each electromagnet essentially consists of a ferromagnetic core which has one or more turns of wire wrapped around it. For the purposes of this disclosure, a “turn” of wire is a single loop of wire around the core. A “coil” of wire is a wire that is wrapped around the core multiple times to form multiple loops, or turns, of wire. When electric current is conducted by the coil, magnetic fields that are generated around the wire induce a magnetic field through the core. Alternating current in the wire alternates the magnetic field orientation generated by the electromagnet.

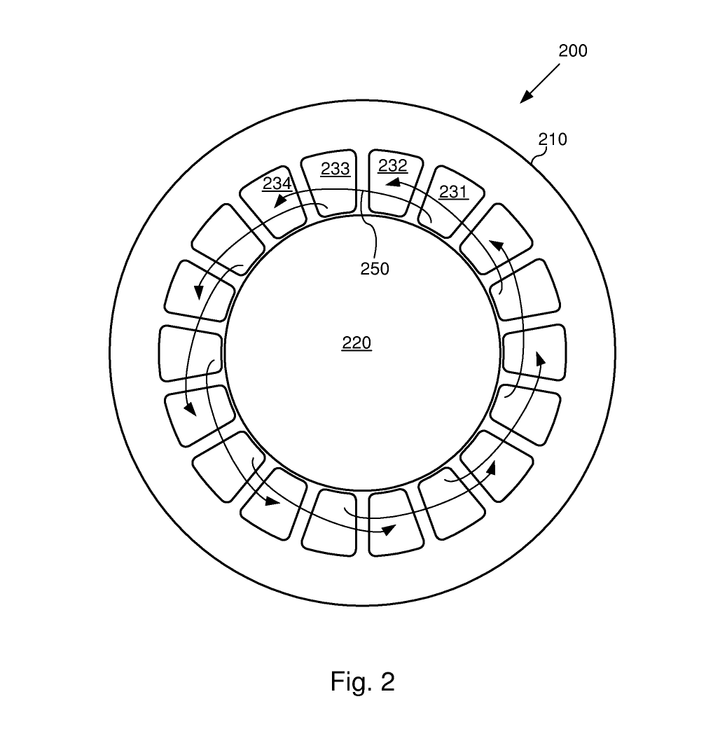

Referring to FIG. 2, a diagram illustrating the end of a stator body in accordance with one embodiment is shown. This particular stator body is designed for use in an AC induction motor of an electric submersible pump. The stator body 200 is generally annular, with a cylindrical outer portion 210 and a cylindrical space 220 in its center. In this embodiment, a plurality of passageways (e.g., 231-234) are formed in stator body 200. These passageways may also be referred to as “slots” because they are often open to the cylindrical space in the center of the stator, but in this embodiment they are closed, forming tubular passageways through the stator body.

The passageways (e.g., 231-234) extend entirely through the stator so that wires can be threaded through the passageways. A wire is threaded through one passageway and back through a different passageway to form a turn of wire. The wire is threaded through these same passageways multiple times to form a coil. The walls between the passageways (e.g., 241-243) serve as ferromagnetic cores, so that when a wire is wrapped around one or more of them, an electromagnet is formed. Although a wire could be threaded through adjacent passageways in the stator body, this embodiment forms each coil bypassing a wire through non-adjacent passageways. Thus, for example, a wire may be threaded upward through passageway 231, and then back through passageway 234, as shown by arrow 250. The other arrows in the figure show how wires are threaded through the other passageways to form the remaining wire coils.

The wires that are threaded through the passageways in the stator body are typically copper wires that have an insulating coating. This insulating coating is intended to electrically insulate each turn of wire from the others so that current will pass through each of the turns, rather than bypassing one or more turns of wire if a short-circuit is created by electrical contact between the wire of two or more turns. Although the wire is insulated, it is typical to provide a layer of insulation between the wires and the walls of the passageways or slots (the “ground walls”). This layer of insulation is typically referred to as ground wall insulation, or as a slot liner because it lines the slot. The slot liner provides additional insulation between the wires, which may have high electrical potentials, and the body of the stator, which is typically at a ground potential. Because all of the turns of wire in a coil are located within a slot liner, however, this does not prevent partial discharge between the turns of wire in the coil.

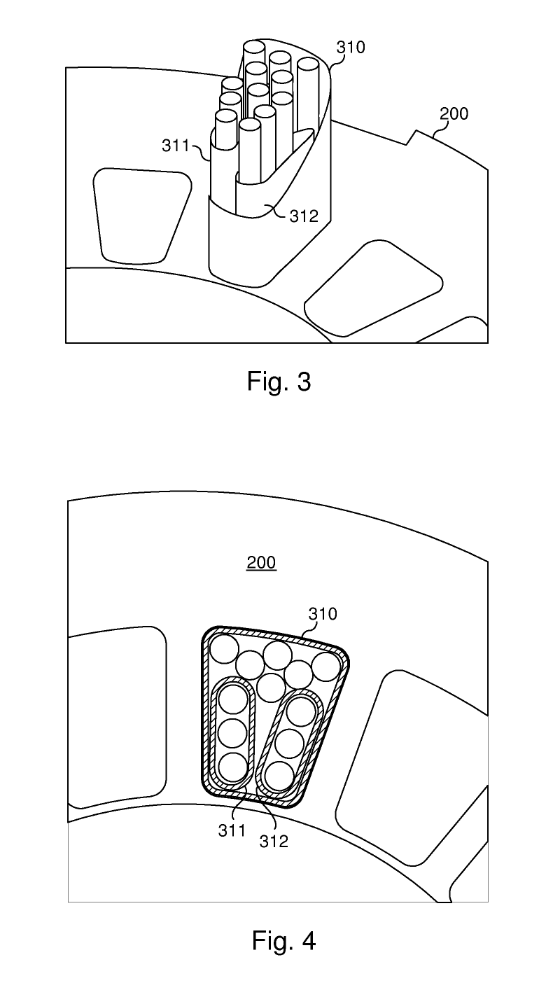

Referring to FIGS. 3 and 4, a pair of diagrams illustrating the use of insulating barriers between wire turns of a single coil are shown. FIG. 3 is a perspective view of wire turns within a single slot of stator body 200, while FIG. 4 is a cutaway view of the wire turns in the slot. Each of the wires shown in FIGS. 3 and 4 corresponds to a different turn of the same coil.

As shown in FIGS. 3 and 4, a slot liner 310 is installed within one of the passageways within stator body 200. Slot liner 310 is a tubular insulator that is inserted into the passageway before any of the turns of wire are installed. Slot liner 310 extends all the way through the passageway. In this embodiment, two more tubular insulators (311, 312) are then inserted within the slot liner. Tubular insulators 311 and 312 also extend all the way through the passageway. After tubular insulators 311 and 312 have been installed, the wire coil can be installed in the passageway.

Because stator body 200 has enclosed passageways, rather than slots which are open to the cylindrical space in the center of the stator body, it is necessary to construct the wire coil by threading a wire through one of the passageways and then back through another of the passageways for each turn in the coil. Because the stator may be very long, it may be difficult or even impossible to control the positioning of the wires within the passageway, so this is considered to be a random-wound, rather than a form-wound, coil.

In this case, though wire is threaded through tubular insulator 311 for three turns, through tubular insulator 312 for three turns, and through slot liner 310 (but outside tubular insulators 311 and 312) for six turns. Because the additional electrical insulation provided by tubular insulators 311 and 312 is intended to reduce electrical stress (hence reduce partial discharge) between turns of wire that have large differences in electrical potential, the first three turns of the coil will be inserted through a first one of the tubular insulators (e.g., 311), then six turns will be inserted through the slot liner outside tubular insulators 311 and 312, then the last three turns will be inserted through the second of the tubular insulators (e.g., 312). Thus, the turns of wire having the highest potential are positioned within one tubular insulator (e.g., 311) and the turns of wire having the lowest potential are positioned within the other tubular insulator (e.g., 312), providing two additional layers of electrical insulation between the turns of wire having the greatest potential difference.

Both slot liner 310 and tubular insulators 311 and 312 may be formed in a variety of ways. In one embodiment, each of these insulators is a separately formed tube. The tubes may be individually extruded, spiral-wound, or otherwise formed, and then the tubular insulators may be positioned within the slot liner. Although, in the description above, all of these insulators are inserted in the passageway in the stator body before any of the wire turns are installed, this is not necessarily the case, and one or more of the tubular insulators may be installed after one more of the wire turns. In an alternative embodiment, two or more of the insulators may be formed as a single unit. For example, the slot liner and one or more of the tubular insulators may be extruded as a single structure having multiple passageways therethrough and insulating walls between the passageways. This integrally formed set of insulators would be installed in the passageway of the stator body prior to installation of the wire turns. Still other means of constructing these insulators may also be possible.

The slot liner and tubular insulators may also use various, different insulating structures. For instance, in one embodiment, both the slot liner and tubular insulators use nonconductive insulating materials. In alternative embodiments, these insulators may incorporate semi-conductive or conductive layers rather than only nonconductive materials.

It should also be noted that, while the insulating barriers (tubular insulators 311, 312) are shown in FIGS. 3 and 4 isolating the wire turns only in the passageway, the insulating barriers may (although it is not necessary) be allowed to extend out of the passageway to isolate the portions of the wire turns that reach from one passageway to another.

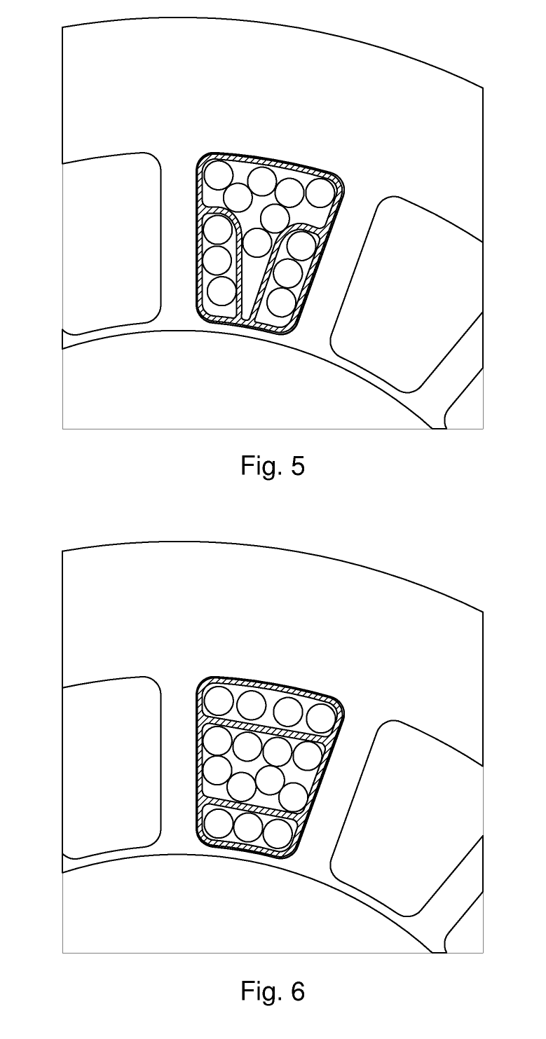

Referring to FIGS. 5-7, a set of diagrams illustrating alternative configurations of the slot liner and tubular insulators are shown. FIG. 5 shows a configuration that is similar to the configuration of FIGS. 3 and 4, except that the tubular insulators are integral to the slot liner in this embodiment. As noted above, this may be accomplished by extruding the slot liner and tubular insulators as a single unit. It can be seen in the figure that a first set of the wire turns is isolated at the lower left-hand corner of the passageway, and a second set of wire turns is isolated at the lower right-hand corner of the passageway. The remainder of the wire turns are positioned in the top of the passageway and are isolated from both the first and second sets of turns.

Referring to FIG. 6, the tubular insulators are integral to the slot liner as in the embodiment of FIG. 5. In the embodiment of FIG. 6, however, the tubular insulators are positioned differently. Here, a first set of wire turns (e.g., the high-potential turns) is isolated at the bottom of the passageway, while a second set of wire turns (e.g., the low-potential turns) is isolated at the top of the passageway. The remainder of the turns are positioned between these two sets of turns. In this embodiment, the high-potential turns are not only electrically isolated from the low-potential turns by additional layers of insulation—they are isolated by positioning these sets of turns on opposite sides of the mid-potential turns in the center of the slot liner. This may provide additional protection against partial discharge.

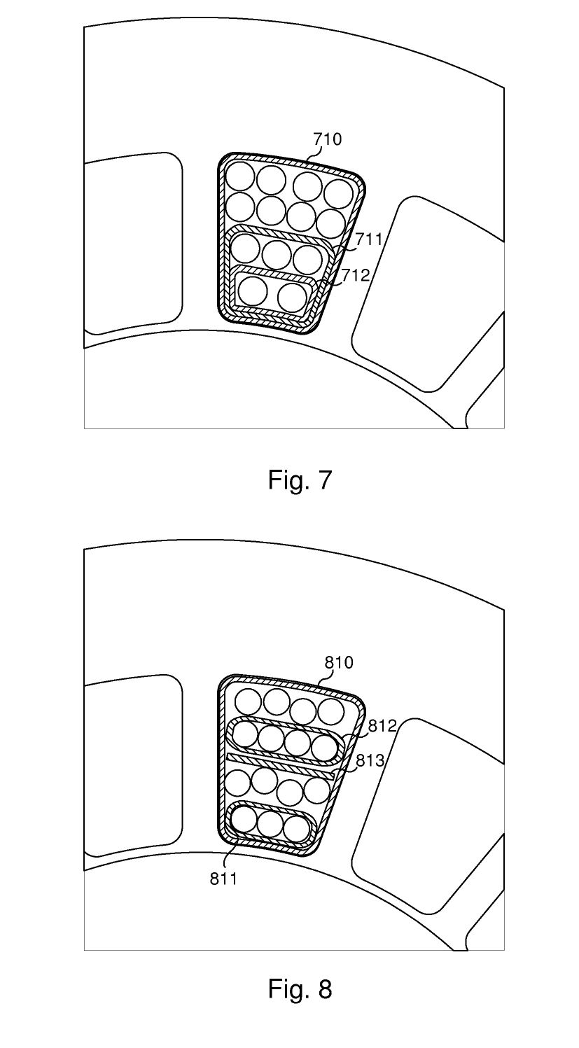

Referring to FIG. 7, another alternative configuration of the slot liner and tubular insulators is shown. In this embodiment, a first tubular insulator 711 is placed within slot liner 710, and a second tubular insulator 712 is placed within the first tubular insulator 711. Thus, it is not necessary that each of the tubular insulators be separately positioned within the slot liner, but may instead be nested within each other. It should also be noted that, in this and other embodiments, the number of wire turns that are positioned within each tubular insulator may vary, and it is not necessary to positioned the same number of turns within each tubular insulator. Similarly, the number of tubular insulators that are positioned within the slot liner may vary.

Referring to FIG. 8, another alternative configuration in which two coils are installed in the same slot is shown. The coils may be from the same or different phases or poles of the motor. In this embodiment, a first tubular insulator 811 is placed within slot liner 810. A first set of wire turns are then installed in tubular insulator 811, and a second set of wire turns are installed outside tubular insulator 811, but inside slot liner 810. The first and second sets of wire turns comprise a first wire coil. An insulating barrier 813 is then positioned between the wire turns of the first coil and the remaining space in the slot, and a second tubular insulator 812 is positioned in the slot. A third set of wire turns are then installed in tubular insulator 812. A fourth set of wire turns are installed outside tubular insulator 812, but inside slot liner 810. The third and fourth sets of wire turns comprise a second wire coil.

As noted above, while the embodiments described in detail above are implemented in the stator of an electric motor, alternative embodiments of the invention may be implemented alternatively or additionally in the rotor. Further, while the foregoing embodiments are implemented in a stator having closed passageways rather than slots which are open to the cylindrical space in the center of the stator, alternative embodiments may be implemented in stators (or rotors) that have open slots or other configurations. The various embodiments may be implemented in any type of motor.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. An electric motor comprising:
a stator; and
a rotor positioned coaxially within the stator;
wherein the stator has a plurality of passageways therethrough;
wherein the stator has a plurality of wire coils, each coil having multiple wire turns;
wherein each passageway has the wire turns of one or more of the wire coils positioned therein; and
wherein each passageway also has one or more insulating barriers therein which separate at least a first plurality of the wire turns in a first one of the wire coils in the passageway from a second plurality of the wire turns in the first one of the wire coils in the passageway.

2. The electric motor of claim 1, wherein the first plurality of the wire turns in each passageway includes a first wire turn having a maximum electrical potential in the coil and the second plurality of the wire turns in the passageway includes a last wire turn having a minimum electrical potential in the coil.

3. The electric motor of claim 2, wherein at least a third plurality of wire turns is positioned between the first plurality of the wire turns and the second plurality of the wire turns.

4. The electric motor of claim 1, wherein each passageway has an insulating slot liner positioned therein between the walls of the passageway and all of the wire turns that are positioned within the passageway.

5. The electric motor of claim 1, wherein the one or more insulating barriers within each passageway are integral to the slot liner.

6. The electric motor of claim 5, wherein the slot liner and the one or more insulating barriers are formed by a single extrusion.

7. The electric motor of claim 1, wherein the one or more insulating barriers within each passageway comprise tubular insulators which are formed separately from the slot liner and are positioned within the slot liner.

8. The electric motor of claim 7, wherein one or more of the slot liner and the insulating barriers are spiral-wound tubular insulators.

9. The electric motor of claim 1, wherein each of the wire turns comprises a portion of a single wire, wherein the wire has an insulating coating which is separate from the insulating barriers.

10. The electric motor of claim 1, wherein each of the wire turns is random-wound on the stator.

11. A method for manufacturing a stator for an electric motor, the method comprising:
providing a stator body having a plurality of passageways therethrough;
installing one or more insulating barriers within each passageway; and
within each passageway, installing multiple wire turns of a single wire coil, wherein the insulating barriers within the passageway separate at least a first plurality of the wire turns in the passageway from a second plurality of the wire turns in the passageway.

12. The method of claim 11, further comprising installing a slot liner within each of the passageways between the walls of the passageway and all of the wire turns that are positioned within the passageway.

13. The method of claim 12, wherein installing the insulating barriers and installing a slot liner comprises installing a slot liner with integrally formed insulating barriers.

14. The method of claim 12, wherein installing the insulating barriers comprises installing within the slot liner tubular insulators which are formed separately from the slot liner.

15. The method of claim 11, wherein installing multiple wire turns comprises installing a first wire turn having a maximum electrical potential in the coil in the first plurality of the wire turns and installing a last wire turn having a minimum electrical potential in the coil in the second plurality of the wire turns.

16. The method of claim 15, further comprising installing at least a third plurality of wire turns in a location in the passageway between the first plurality of the wire turns and the second plurality of the wire turns.

17. The method of claim 11, wherein installing the multiple wire turns comprises installing turns of a single wire that has an insulating coating which is separate from the insulating barriers.

18. The method of claim 11, wherein installing the multiple wire turns comprises installing the wire turns in a random-wound fashion on the stator.

19. An electromagnet in an electric motor comprising:
a ferromagnetic core;
a wire coil comprising a wire formed into a plurality of turns, wherein the wire coil is positioned around the ferromagnetic core; and
one or more insulating barriers, wherein the insulating barriers separate at least a first plurality of the turns of wire in the coil from a second plurality of the turns of wire in the coil.

20. The electromagnet of claim 19, wherein the first plurality of the wire turns in each passageway includes a first wire turn having a maximum electrical potential in the coil and the second plurality of the wire turns in the passageway includes a last wire turn having a minimum electrical potential in the coil.
